(19) United States
(12) Patent Application Publication
(10) Pub. No.: US 2015/0227651 A1
(43) Pub. Date: Aug. 13, 2015

(54) LIQUID FLOW SIMULATION TECHNIQUES

(71) Applicant: QUALCOMM Incorporated, San Diego, CA (US)

(72) Inventors: Radhika Dilip Gowaikar, San Diego, CA (US); Christopher Gerard Lott, San Diego, CA (US)

(21) Appl. No.: 14/584,916

(22) Filed: Dec. 29, 2014

Related U.S. Application Data
(60) Provisional application No. 61/939,636, filed on Feb. 13, 2014.

(51) Int. Cl. G06F 17/50

(52) U.S. Cl. CPC G06F 17/5009; G06F 17/5018

(57) ABSTRACT

This disclosure describes techniques for simulating liquid flow. The techniques for simulating liquid flow may involve generating provisional particle positions based on one or more physical forces, and modifying the provisional particle positions based on one or more target densities for the particles. For example, the provisional particle positions may be modified based on a function that defines an aggregate density deviation for the particles as a function of current particle positions for the particles and one or more target densities for the particles. The liquid flow techniques of this disclosure may allow an incompressible liquid flow to be realistically simulated with reduced computational and/or power requirements relative to simulators that solve or approximate solutions to Navier-Stokes equations, thereby making such techniques particularly useful for simulating liquid flows in power-limited and/or computational resource-limited devices (e.g., mobile phones).

This application claims the benefit of U.S. Provisional Application No. 61/939,636, filed Feb. 13, 2014, the entire content of which is incorporated herein by reference.

### TECHNICAL FIELD

This disclosure relates to simulation techniques, and more particularly, to particle-based simulation techniques.

### BACKGROUND

Physics engines may be used in gaming applications to simulate realistic interactions involving rigid bodies, soft bodies, fluids, and other physical objects and/or systems. The algorithms used to simulate such phenomena are often computationally complex, which may make such algorithms difficult to implement in processing environments that have a limited amount of computational resources, computational speed, and/or power resources, such as, e.g., a mobile device and/or a mobile phone.

### SUMMARY

This disclosure describes techniques for simulating liquid flow. The techniques for simulating liquid flow may involve generating provisional particle positions based on one or more physical forces, and modifying the provisional particle positions based on one or more target densities for the particles. For example, the provisional particle positions may be modified based on a function that defines an aggregate density deviation for the particles as a function of current particle positions for the particles and one or more target densities for the particles. The liquid flow techniques of this disclosure may allow an incompressible liquid flow to be realistically simulated with reduced computational and/or power requirements relative to simulators that solve or approximate solutions to Navier-Stokes equations, thereby making such techniques particularly useful for simulating liquid flows in power-limited and/or computational resource-limited devices (e.g., mobile phones).

In one example, this disclosure describes a method that includes obtaining initial particle positions for a plurality of particles that model a fluid and initial particle velocities for the plurality of particles. The method further includes generating provisional particle positions for the particles based on the initial particle positions, the initial particle velocities, and a model that models one or more physical forces to be applied to the fluid. The method further includes generating modified particle positions for the particles based on the provisional particle positions, one or more target densities for the particles, and a function that defines an aggregate density deviation for the particles as a function of particle-specific density deviations. Each of the particle-specific density deviations is a function of an amount by which a density for a respective one of the particles differs from one of the target densities. The density for the respective one of the particles is a function of current particle positions.

In another example, this disclosure describes a device that includes one or more processors configured to obtain initial particle positions for a plurality of particles that model a fluid and initial particle velocities for the plurality of particles. The one or more processors are further configured to generate provisional particle positions for the particles based on the initial particle positions, the initial particle velocities, and a model that models one or more physical forces to be applied to the fluid. The one or more processors are further configured to generate modified particle positions for the particles based on the provisional particle positions, one or more target densities for the particles, and a function that defines an aggregate density deviation for the particles as a function of particle-specific density deviations. Each of the particle-specific density deviations is a function of an amount by which a density for a respective one of the particles differs from one of the target densities. The density for the respective one of the particles is a function of current particle positions.

In another example, this disclosure describes an apparatus that includes means for obtaining initial particle positions for a plurality of particles that model a fluid and initial particle velocities for the plurality of particles. The apparatus further includes means for generating provisional particle positions for the particles based on the initial particle positions, the initial particle velocities, and a model that models one or more physical forces to be applied to the fluid. The apparatus further includes means for generating modified particle positions for the particles based on the provisional particle positions, one or more target densities for the particles, and a function that defines an aggregate density deviation for the particles as a function of particle-specific density deviations. Each of the particle-specific density deviations is a function of an amount by which a density for a respective one of the particles differs from one of the target densities. The density for the respective one of the particles is a function of current particle positions.

In another example, this disclosure describes a computer-readable storage medium storing instructions that, when executed, cause one or more processors to obtain initial particle positions for a plurality of particles that model a fluid and initial particle velocities for the plurality of particles. The instructions further cause the one or more processors to generate provisional particle positions for the particles based on the initial particle positions, the initial particle velocities, and a model that models one or more physical forces to be applied to the fluid. The instructions further cause the one or more processors to generate modified particle positions for the particles based on the provisional particle positions, one or more target densities for the particles, and a function that defines an aggregate density deviation for the particles as a function of particle-specific density deviations. Each of the particle-specific density deviations is a function of an amount by which a density for a respective one of the particles differs from one of the target densities. The density for the respective one of the particles is a function of current particle positions.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that may be used to implement the fluid flow simulation techniques of this disclosure.

FIG. 2 is a flow diagram illustrating an example technique for simulating fluid flow according to this disclosure.

FIG. 3 is a flow diagram illustrating an example technique for performing a forced-based particle position update according to this disclosure.

FIG. 4 is a flow diagram illustrating an example technique for performing a density-based particle position update according to this disclosure.

FIG. 5 is a flow diagram illustrating an example technique for selecting particles to include in a gradient descent or ascent iteration according to this disclosure.

FIG. 6 is a flow diagram illustrating an example technique for determining a gradient step according to this disclosure.

FIG. 7 is a flow diagram illustrating an example technique for modifying a position based on a gradient step according to this disclosure.

FIG. 8 is a flow diagram illustrating another example technique for simulating fluid flow according to this disclosure.

FIG. 9 is a diagram illustrating example mean densities that may result when simulating an example pool of liquid using one or more of the techniques of this disclosure.

### DETAILED DESCRIPTION

This disclosure describes techniques for simulating liquid flow. The techniques for simulating liquid flow may involve generating provisional particle positions based on one or more physical forces, and modifying the provisional particle positions based on one or more target densities for the particles. For example, the provisional particle positions may be modified based on a cost function that defines an aggregate density deviation for the particles as a function of current particle positions for the particles and one or more target densities for the particles. The liquid flow techniques of this disclosure may allow an incompressible liquid flow to be realistically simulated with reduced computational and/or power requirements relative to simulators that solve or approximate solutions to Navier-Stokes equations, thereby making such techniques particularly useful for simulating liquid flows in power-limited and/or computational resource-limited devices (e.g., mobile phones).

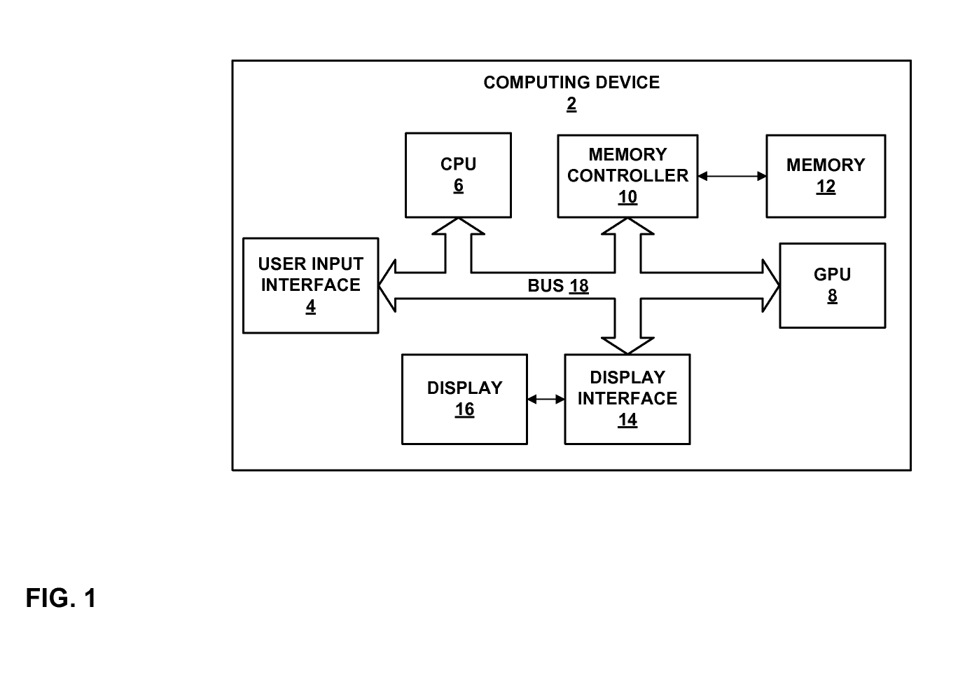

FIG. 1 is a block diagram illustrating an example computing device 2 that may be used to implement the fluid flow simulation techniques of this disclosure. Computing device 2 may comprise a personal computer, a desktop computer, a laptop computer, a computer workstation, a video game platform or console, a wireless communication device (such as, e.g., a mobile telephone, a cellular telephone, a satellite telephone, and/or a mobile phone handset), a landline telephone, an Internet telephone, a handheld device such as a portable video game device or a personal digital assistant (PDA), a personal music player, a video player, a display device, a television, a television set-top box, a server, an intermediate network device, a mainframe computer or any other type of device that processes and/or displays graphical data.

As illustrated in the example of FIG. 1, computing device 2 includes a user input interface 4, a central processing unit (CPU) 6, a graphics processing unit (GPU) 8, a memory controller 10, a memory 12, a display interface 14, a display 16 and a bus 18. User input interface 4, CPU 6, GPU 8, memory controller 10, and display interface 14 may communicate with each other using bus 18. It should be noted that the specific configuration of buses and communication interfaces between the different components shown in FIG. 1 is merely exemplary, and other configurations of computing devices and/or other processing systems with the same or different components may be used to implement the techniques of this disclosure.

User input interface 4 may allow one or more user input devices (not shown) to be communicatively coupled to computing device 2. The user input devices may allow a user to provide input to computing device 2 via user input interface 4. Example user input devices include a keyboard, a mouse, a trackball, a microphone, a touch pad, a touch-sensitive or presence-sensitive display, or another input device. In examples where a touch-sensitive or presence-sensitive display is used as a user input device, all or part of user input interface 4 may be integrated with display 16.

CPU 6 may comprise a general-purpose or a special-purpose processor that controls operation of computing device 2. CPU 6 may execute one or more software applications. The software applications may include, for example, a video game application, a graphics application, a word processor application, an email application, a spread sheet application, a media player application, a graphical user interface application, an operating system, or any other type of software application or program.

GPU 8 may be configured to render and display graphics data that is received from CPU 6. In some examples, GPU 8 may be configured to perform graphics operations to render one or more graphics primitives to display 16. In such examples, when one of the software applications executing on CPU 6 requires graphics processing, CPU 6 may provide graphics data to GPU 8 and issue one or more graphics commands to GPU 8. The graphics commands may include, e.g., draw call commands, GPU state programming commands, memory transfer commands, blitting commands, etc. The graphics data may include vertex buffers, texture data, surface data, etc. In some examples, CPU 6 may provide the commands and graphics data to GPU 8 by writing the commands and graphics data to memory 12, which may be accessed by GPU 8.

GPU 8 may, in some instances, be built with a highly-parallel structure that provides more efficient processing of vector operations than CPU 6. For example, GPU 8 may include a plurality of processing elements that are configured to operate on multiple vertices, control points, pixels and/or other data in a parallel manner. The highly parallel nature of GPU 8 may, in some instances, allow GPU 8 to process tasks that that include a high degree of parallelism more quickly than CPU 6. In addition, the highly parallel nature of GPU 8 may, in some examples, allow GPU 8 to render graphics images (e.g., GUIs and two-dimensional (2D) and/or three-dimensional (3D) graphics scenes) onto display 16 more quickly than rendering the images using CPU 6.

GPU 8 may, in some instances, be integrated into a motherboard of computing device 2. In other instances, GPU 8 may be present on a graphics card that is installed in a port in the motherboard of computing device 2 or may be otherwise incorporated within a peripheral device configured to interoperate with computing device 2. In further instances, GPU 8 may be located on the same microchip as CPU 6 forming a system on a chip (SoC). GPU 8 may include one or more processors, such as one or more microprocessors, application specific integrated circuits (ASICs), field programmable gate arrays (FPGAs), digital signal processors (DSPs), or other equivalent integrated or discrete logic circuitry.

In some examples, GPU 8 may include a GPU cache, which may provide caching services for all or a portion of memory 12. In such examples, GPU 8 may use the cache to process data locally using a local storage, instead of off-chip memory. This allows GPU 8 to operate in a more efficient manner by reducing the need for GPU 8 to access memory 12 via bus 18, which may experience heavy bus traffic, during each read and write command. In some examples, however, GPU 8 may not include a separate cache, but instead utilize memory 12 via bus 18. The GPU cache may include one or more volatile or non-volatile memories or storage devices, such as, e.g., random access memory (RAM), static RAM (SRAM), dynamic RAM (DRAM), etc.

Memory controller 10 facilitates the transfer of data going into and out of memory 12. For example, memory controller 10 may receive memory read and write commands, and service such commands with respect to memory 12 in order to provide memory services for the components in computing device 2. Memory controller 10 is communicatively coupled to memory 12. Although memory controller 10 is illustrated in the example computing device 2 of FIG. 1 as being a processing module that is separate from both CPU 6 and memory 12, in other examples, some or all of the functionality of memory controller 10 may be implemented on one or both of CPU 6 and memory 12.

Memory 12 may store program modules and/or instructions that are accessible for execution by CPU 6 and/or data for use by the programs executing on CPU 6. For example, memory 12 may store program code and graphics data associated with the applications executing on CPU 6. Memory 12 may additionally store information for use by and/or generated by other components of computing device 2. For example, memory 12 may act as a device memory for GPU 8 and may store data to be operated on by GPU 8 as well as data resulting from operations performed by GPU 8. For example, memory 12 may store any combination of buffer objects, pipe data, or the like. In addition, memory 12 may store command streams for processing by GPU 8 (e.g., command queues). Memory 12 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), Flash memory, a magnetic data medium or an optical storage medium. In some examples, memory 12 may correspond to all or part of a data storage system.

CPU 6 and/or GPU 8 may store rasterized image data in a frame buffer that is allocated within memory 12. Display interface 14 may retrieve the data from the frame buffer and configure display 16 to display the image represented by the rasterized image data. In some examples, display interface 14 may include a digital-to-analog converter (DAC) that is configured to convert the digital values retrieved from the frame buffer into an analog signal consumable by display 16. In other examples, display interface 14 may pass the digital values directly to display 16 for processing.

Display 16 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 16 may be integrated within computing device 2. For instance, display 16 may be a screen of a mobile telephone handset or a tablet computer. Alternatively, display 16 may be a stand-alone device coupled to computer device 2 via a wired or wireless communications link. For instance, display 16 may be a computer monitor or flat panel display connected to a personal computer via a cable or wireless link.

Bus 18 may be implemented using any combination of bus structures and bus protocols including first, second and third generation bus structures and protocols, shared bus structures and protocols, point-to-point bus structures and protocols, unidirectional bus structures and protocols, and bidirectional bus structures and protocols. Examples of different bus structures and protocols that may be used to implement bus 18 include, e.g., a HyperTransport bus, an InfiniBand bus, an Advanced Graphics Port bus, a Peripheral Component Interconnect (PCI) bus, a PCI Express bus, an Advanced Microcontroller Bus Architecture (AMBA) Advanced High-performance Bus (AHB), an AMBA Advanced Peripheral Bus (APB), and an AMBA Advanced eXentisible Interface (AXI) bus. Other types of bus structures and protocols may also be used.

In some examples, the techniques for simulating fluid flow described in this disclosure may be implemented in one or both of CPU 6 and GPU 8. For example, CPU 6 may execute one or more software applications or programs that perform all or part of any of the fluid flow simulation techniques of this disclosure. As another example, GPU 8 may be configured to execute one or more shader programs that perform all or part of any of the fluid flow simulation techniques of this disclosure. In additional examples, memory 12 may store one or more programs for execution by CPU 6 and/or GPU 8 that perform any of the fluid flow simulation techniques of this disclosure.

In some examples, CPU 6 and/or GPU 8 may be configured to obtain initial particle positions for a plurality of particles and initial particle velocities for the plurality of particles, generate provisional particle positions and modified particle velocities for the particles based on the initial particle positions, the initial particle velocities, and a model that models one or more physical forces. In such examples, CPU 6 and/or GPU 8 may be further configured to modify the provisional particle positions based on a target density for the particles to generate modified particle positions for the particles.

In further examples, CPU 6 and/or GPU 8 may be configured to obtain initial particle positions for a plurality of particles that model a fluid and initial particle velocities for the plurality of particles, and generate provisional particle positions for the particles based on the initial particle positions, the initial particle velocities, and a model that models one or more physical forces to be applied to the fluid. In such examples, CPU 6 and/or GPU 8 may be further configured to generate modified particle positions for the particles based on the provisional particle positions, one or more target densities for the particles, and a function that defines an aggregate density deviation for the particles as a function of particle-specific density deviations. Each of the particle-specific density deviations may be a function of an amount by which a density for a respective one of the particles differs from one of the target densities. The density for the respective one of the particles may be a function of current particle positions.

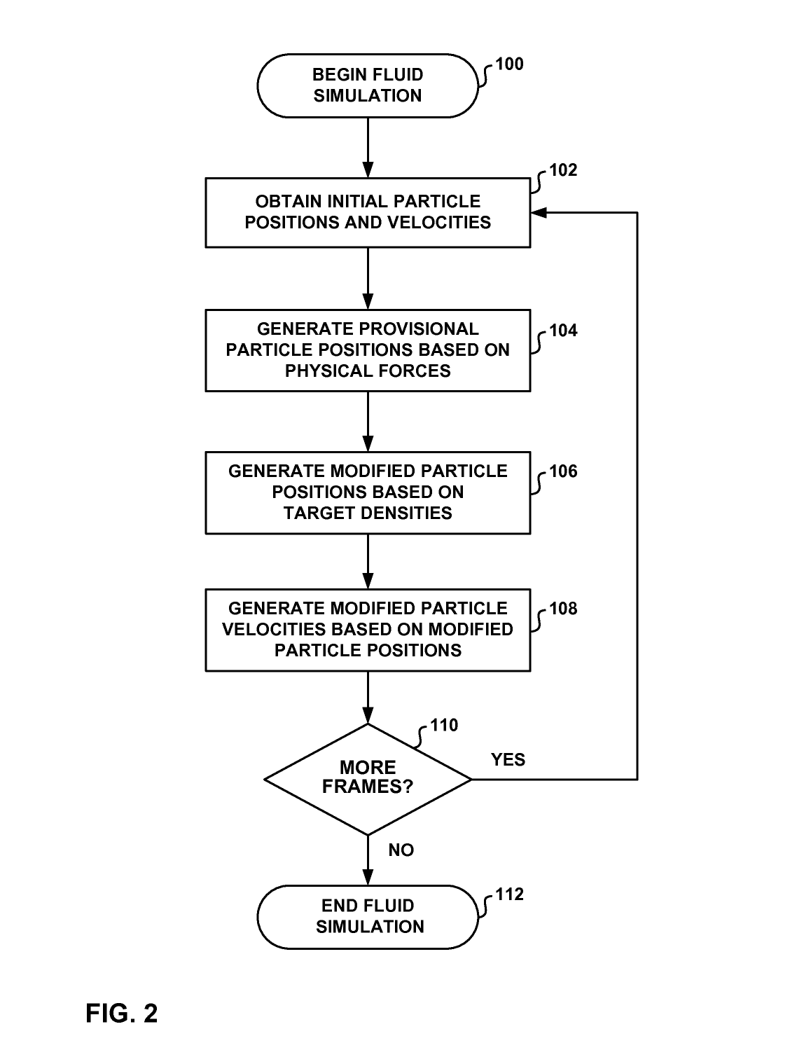

FIGS. 2-8 are flow diagrams illustrating example techniques for simulating fluid (e.g., liquid) according to this disclosure. The techniques illustrated in FIGS. 2-8 are described as being performed by CPU 6 in the computing device 2 of FIG. 1 for exemplary purposes. However, it should be recognized that, in other examples, some or all aspects of the techniques shown in FIGS. 2-8 may be performed by other components in FIG. 1 (e.g., GPU 8) in addition to or in lieu of CPU 6, or performed by one or more devices other than computing device 2 of FIG. 1.

FIG. 2 is a flow diagram illustrating an example technique for simulating fluid flow according to this disclosure. CPU 6 begins the fluid simulation (100). CPU 6 obtains initial particle positions for a plurality of particles that model a fluid and initial particle velocities for the plurality of particles (102). In some examples, the initial particle positions and velocities may be particle positions and velocities associated with particles from a previous frame. In further examples (e.g., if the frame is the first frame in an animation sequence), the initial particle positions and velocities may be obtained or received from a software application (e.g., a graphics application executing on CPU 6). In some examples, CPU 6 may initialize particle positions (x) and velocities (v), and variables for temporary positions (xp) and velocities (vt).

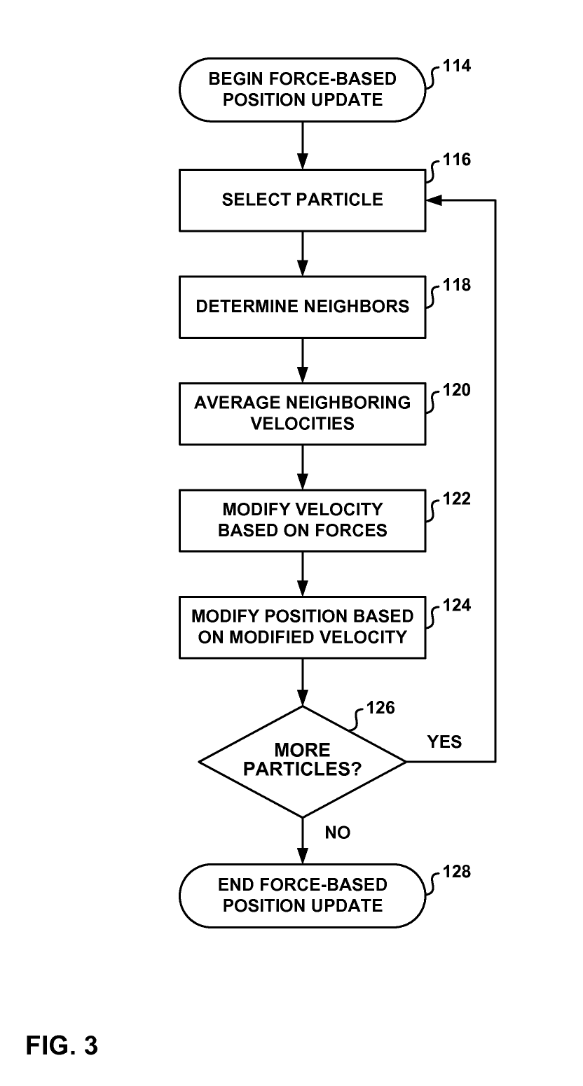

CPU 6 generates provisional particle positions for the particles based on the initial particle positions, the initial particle velocities, and a model that models one or more physical forces to be applied to the fluid (104). In some examples, CPU 6 may generate the provisional particle positions based on a time step in addition to the other factors listed above. In some examples, CPU 6 may use the technique illustrated in FIG. 3 to generate the provisional particle positions.

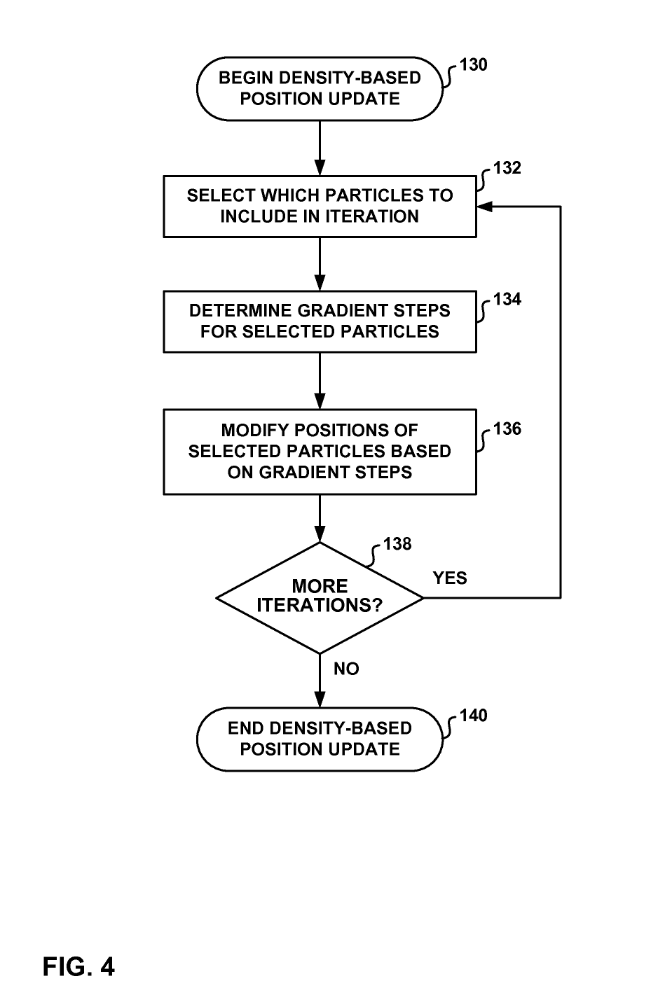

CPU 6 generates modified particle positions for the particles based on one or more target densities (106). For example, CPU 6 may generate the modified particle positions based on the provisional particle positions, one or more target densities for the particles, and a function that defines an aggregate density deviation for the particles as a function of particle-specific density deviations. Each of the particle-specific density deviations may be a function of an amount by which a density for a respective one of the particles differs from one of the target densities. The density for the respective one of the particles may be a function of current particle positions. As such, the function may be said to define the aggregate density deviation as a function of current particle positions. In some examples, the function that defines the aggregate density deviation may be referred to as an objective function, a cost function and/or a utility function. In some examples, CPU 6 may use the technique illustrated in FIG. 4 to generate the modified particle positions.

CPU 6 generates modified particle velocities based on the modified particle positions (108). In some examples, CPU 6 may generate the modified particle velocities based on a time step and the modified particle positions. For example, CPU 6 may generate the modified particle velocities such that each of the modified particle velocities corresponds to an average rate of change between a particle position and a modified particle position. In other words, CPU 6 may update the particle velocities to reflect the changes in particle position that took place in process block 106.

CPU 6 determines whether there are additional frames to be simulated (i.e., animated) as part of the simulation (110). In response to determining that there are additional frames to be simulated, CPU 6 proceeds to process block 102 to obtain initial particle positions and velocities for the next frame. The initial particle positions and velocities for the next frame may correspond, respectively, to the modified particle positions and velocities that were generated for the previous frame in process blocks 106 and 108, respectively. On the other hand, in response to determining that there are no additional frames to be simulated, CPU 6 ends the fluid simulation process (112). CPU 6 may, in some examples, repeat process blocks 102, 104, 106 and 108 for each of the frames to be simulated.

In some examples, CPU 6 may use one or more of the following parameters to perform the technique illustrated in FIG. 2: a parameter indicative of a target density for one or more particles (desiredRho), a parameter indicative of a radius for determining neighboring particles (h), a parameter indicative of a radius for determining neighboring particles for viscosity control (hv), a parameter indicative of the number of gradient descent or ascent iterations performed for all particles (numFixedIters), a parameter indicative of a total number of gradient descent or ascent iterations performed (numTotalIters), a gradient step threshold above which particles are not included in a subsequent gradient descent or ascent iteration (delP_threshold), a time step parameter (dt), a gradient step threshold used to cap gradient step dimensions (maxDelP).

In some examples, CPU 6 may generate provisional particle positions (104) based on one or more of h, hv, or dt in addition to the previously-mentioned one or more physical forces. In further examples, CPU 6 may generate modified particle positions (106) based on one or more of numTotalIters, delP_threshold, numFixedIters, desiredRho, h, or maxDelP in addition to the previously-mentioned provisional particle positions and aggregate density deviation function. In additional examples, CPU 6 may generate modified particle velocities (108) based on dt in addition to the previously-mentioned modified particle positions.

In some examples, CPU 6 may store the provisional particle position generated in process block 104 in the temporary particle position variable (xp). In further examples, in addition to generating a provisional particle position as part of process block 104, CPU 6 may generate a provisional particle velocity (e.g., by using velocity averaging) and store the provisional particle velocity in the velocity variable (v). In additional examples, CPU 6 may store the modified particle generated in process block 106 in the temporary particle position variable (xp).

As shown in FIG. 2, CPU 6 may initialize the particles, and for each of the frames: (1) apply forces (e.g., gravity) to the particles (104), solve for incompressibility using gradient descent iterations (106), and update positions and velocities (106, 108). These techniques may, in some examples, allow an incompressible liquid flow to be realistically simulated with reduced computational and/or power requirements relative to simulators that solve or approximate solutions to Navier-Stokes equations, thereby making such techniques particularly useful for simulating liquid flows in power-limited and/or computational resource-limited devices (e.g., mobile phones).

FIG. 3 is a flow diagram illustrating an example technique for performing a forced-based particle position update according to this disclosure. In some examples, the technique illustrated in FIG. 3 may be used to implement process block 104 of FIG. 2.

CPU 6 begins the force-based particle position update (114). CPU 6 selects a particle to update (116).

CPU 6 determines the neighboring particles of the selected particle (118). In some examples, CPU 6 may determine the neighboring particles based on a radius. For example, CPU 6 may identify all particles that are within a particular radius of the selected particle as being neighboring particles for the selected particle. In some examples, the radius used to determine the neighboring particles may correspond to the h parameter discussed above. In further examples, the radius used to determine the neighboring particles may correspond to the hv parameter discussed above. In additional examples, CPU 6 may determine a first set of neighboring particles based on radius h, and a second set of neighboring particles based on radius hv. While the hv parameter may be used to manipulate viscosity, in that a greater value for the hv parameter may denote greater viscosity, the h parameter may determine neighbors that affect the density computation. For a given value for the h parameter, the corresponding hv parameter may be greater or smaller.

CPU 6 averages the velocities associated with the neighboring particles and the selected particle to generate an average particle velocity for the selected particle (120). In some examples, CPU 6 may apply a smoothing function to the velocities for the neighboring particles and the selected particle to generate the average particle velocity. For example, CPU 6 may generate the average particle velocity based on the following equation:

v=avg(vt) (1)

where v corresponds to the average particle velocity for the selected particle, and avg(vt) corresponds to the average of the initial particle velocities (vt) for all neighboring particles and the selected particle.

In some examples, CPU 6 may determine the neighboring particles for the velocity averaging performed in process block 120 using the hv parameter. In such examples, the hv parameter may be adjusted to control or manipulate the viscosity of the fluid. In examples where CPU 6 does not actively control the viscosity of the fluid, CPU 6 may determine the neighboring particles for the velocity averaging performed in process block 120 using the h parameter.

CPU 6 modifies the average particle velocity for the selected particle based on one or more forces to generate a modified velocity for the selected particle (122). In some examples, the one or more forces may include one or more of a gravitational force (i.e., gravity). The one or more forces, in some examples, may be external forces, such as the whole system moving under a force (e.g., a container being pushed or objects falling into the system and moving the particles) and the like.

In further examples, CPU 6 may modify the average particle velocity for the selected based on the one or more forces and a time step to generate the modified velocity. In such examples, the time step may correspond to an amount of time between consecutive frames of the simulation or animation.

In some examples, CPU 6 may generate the average particle velocity based on the following equation:

v=v+g·dt (2)

where the v on the left-hand side of equation (2) corresponds to the modified velocity for the selected particle, the v on the right-hand side of equation (2) corresponds to the average particle velocity for the selected particle (e.g., generated by process block 120), g corresponds to a gravitational force to be applied to the particle, and dt corresponds to a time step over which the gravitation force is applied (e.g., the time between consecutive frames).

In some examples, CPU 6 may not perform velocity averaging on the particles prior to applying the forces to the particles. In such examples, the v on the right-hand side of equation (2) may correspond to the initial particle velocity of the selected particle.

CPU 6 modifies the particle position of the selected particle based on the modified velocity for the selected particle to generate a modified position for the particle (124). In some examples, CPU 6 may generate the modified particle position based on the following equation:

x=x+v·dt (3)

where the x on the left-hand side of equation (3) corresponds to the modified position for the selected particle, the x on the right-hand side of equation (3) corresponds to the initial particle position for the selected particle, v corresponds to modified velocity for the selected particle (e.g., generated by process block 122), and dt corresponds to a time step over which the modified velocity is applied (e.g., the time between consecutive frames).

The modified position generated by process block 124 may correspond to a provisional particle position for the selected particle. Similarly, the modified velocity generated by process block 122 may correspond to a provisional particle velocity for the selected particle.

CPU 6 determines whether there are any additional particles to be updated (126). In response to determining that there are additional particles to be updated, CPU 6 proceeds to process block 116 to select the next particle to update. Otherwise, in response to determining that all particles have been updated based on the forces, CPU 6 ends the force-based position update (128). CPU 6 may, in some examples, repeat process blocks 118, 120, 122, and 124 for each of the particles to be simulated in a frame.

As discussed above, the technique shown in FIG. 3 may be used to implement process block 104 in FIG. 2. The modified positions generated by process block 124 in FIG. 3 may correspond to the provisional particle position generated by process block 104 in FIG. 2. In some examples, while performing process block 104 in FIG. 2, CPU 6 may also generate provisional particle velocities, which may correspond to the provisional particle velocities generated by process block 122 in FIG. 3. One or both of the provisional particle positions and provisional particle velocities may be used in process block 106 of FIG. 2 to generate the modified particle positions.

FIG. 4 is a flow diagram illustrating an example technique for performing a density-based particle position update according to this disclosure. In some examples, the technique illustrated in FIG. 4 may be used to implement process block 106 of FIG. 2.

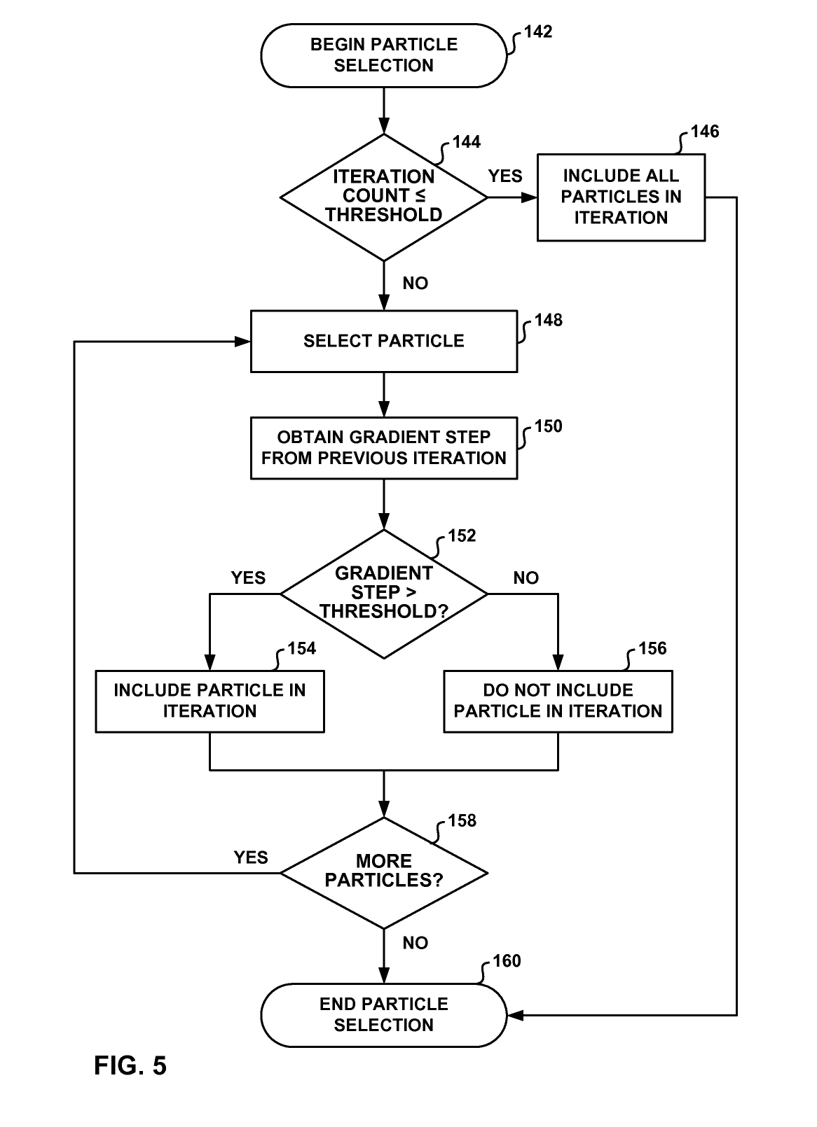

CPU 6 begins the density-based particle position update (130). CPU 6 selects or determines which particles to include in the current gradient descent or ascent iteration (132). In some examples, CPU 6 may use the technique illustrated in FIG. 5 to select or determine which particles to include in the iteration.

CPU 6 selects or determines which particles to include in a gradient descent or ascent iteration (132). In some examples, CPU 6 may use the technique illustrated in FIG. 5 to select or determine which particles to include in the iteration.

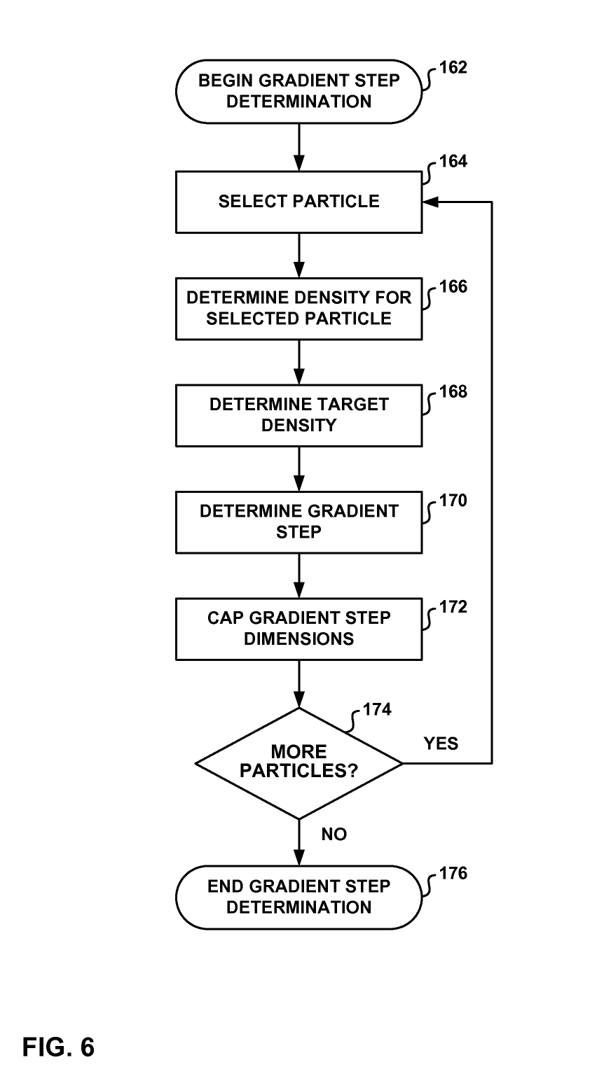

CPU 6 determines gradient steps for the selected particles (134). In some examples, CPU 6 may use the technique illustrated in FIG. 6 to determine the gradient steps for the selected particles.

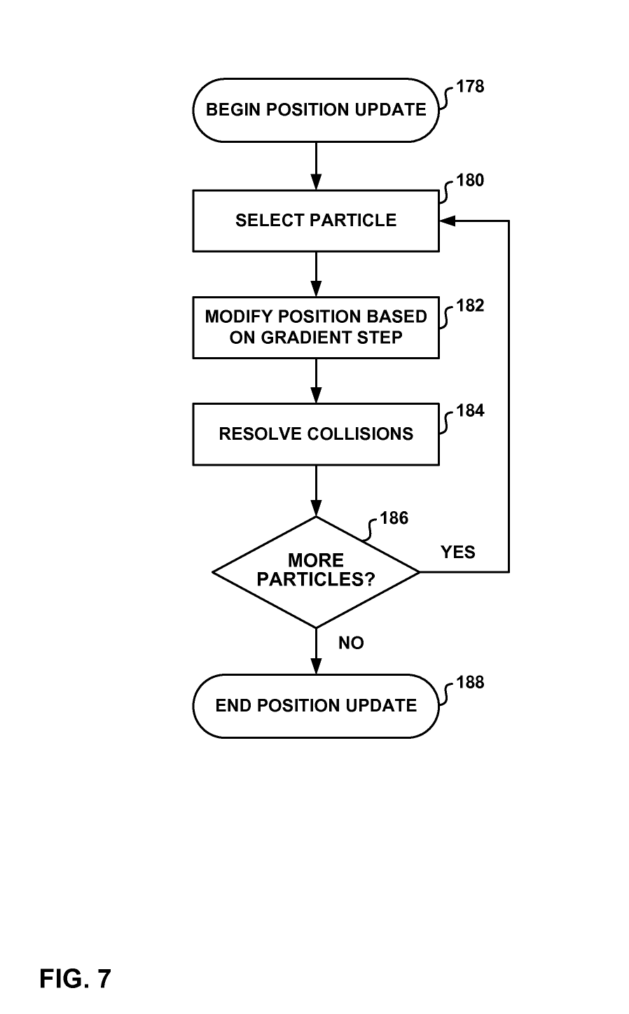

CPU 6 modifies the positions of the selected particles based on the gradient steps to generate modified particle positions for the selected particles (136). In some examples, CPU 6 may use the technique illustrated in FIG. 7 to determine the modified particle positions.

CPU 6 determines whether there are additional iterations (e.g., gradient descent or ascent iterations) to be performed as part of the simulation for the particular frame (138). In response to determining that there are additional iterations to be performed, CPU 6 proceeds to process block 132 to determine which particles to include in the next iteration. On the other hand, in response to determining that there are no additional iterations to be performed, CPU 6 ends the density-based position update (140). CPU 6 may, in some examples, repeat process blocks 132, 134 and 136 for each of the iterations to be performed.

In some examples, CPU 6 may determine whether there are additional iterations to be performed based on the numTotalIters parameter discussed above. In such examples, if the number of iterations that have already been performed is less than the numTotalIters parameter, then CPU 6 may determine to perform another iteration. Otherwise, if the number of iterations that have already been performed is greater than or equal to the numTotalIters parameter, then CPU 6 may determine not to perform another iteration.

In some examples, the gradient descent or ascent iterations may be performed with respect to an objective function (e.g., a cost function or a utility function) that defines a metric indicative of a level of incompressibility of the fluid based on current particle positions. Each gradient descent or ascent iteration may modify the particle positions such that the particles better approximate those of an ideal incompressible fluid.

For example, the objective function may define an aggregate density deviation metric that aggregates the deviation between the actual density (calculated based on current positions) and target density for each of the particles. A lower aggregate density deviation may indicate that the particle positions approximate an incompressible fluid better than particle positions associated a higher aggregate density deviation. Each of the gradient step iterations may, in some examples, determine a gradient step that is targeted at approximating a solution (i.e., a set of particle positions) where the aggregate density deviation is zero.

In some examples, the objective function may include a sum of squared errors. In such examples, solving the objective function to determine the particle positions that simulate an incompressible fluid may take the form of a quadratic minimization problem. In some examples, the technique shown in FIG. 4 may be performed by a solver unit in a physics-based simulator.

In some examples, CPU 6 may select which particles to include in an iteration (132) based on one or more of the numTotalIters, delP_threshold, or numFixedIters parameters. In further examples, CPU 6 may determine gradient steps for the particles (134) based on one or more of desiredRho or h parameters.

FIG. 5 is a flow diagram illustrating an example technique for selecting particles to include in a gradient descent or ascent iteration according to this disclosure. In some examples, the technique illustrated in FIG. 5 may be used to implement process block 132 of FIG. 4.

CPU 6 begins the particle selection process (142). CPU 6 determines whether the iteration count for the current iteration is less than or equal to a threshold (144). CPU 6 may perform a sequence of gradient descent or ascent iterations to determine a set of modified particle positions. In some examples, the threshold may correspond to the numFixedIters parameter discussed above with respect to FIG. 2.

The iteration count may be indicative of which iteration in the sequence of gradient descent or ascent iterations corresponds to the current iteration. In response to determining that the iteration count for the current iteration is less than or equal to the threshold, CPU 6 selects all of the particles for inclusion in the current iteration (146), and proceeds to process block 160 to end the particle selection operation. On the other hand, in response to determining that the iteration count for the current iteration is greater than the threshold, CPU 6 proceeds to process and select particles on a particle-by-particle basis based on the gradient steps that were determined for a previous gradient descent or ascent iteration.

For example, as shown in FIG. 5, CPU 6 selects a particle for processing (148). CPU 6 obtains the gradient step corresponding to the selected particle for the previous iteration (150). CPU 6 determines whether the gradient step from the previous iteration for the selected particle is greater than a threshold (152). The threshold used in process block 152 may be different the threshold used in process block 144. In some examples, the threshold may correspond to the delP_threshold parameter discussed above with respect to FIG. 2.

In response to determining that the gradient step is greater than the threshold, CPU 6 may select the particle for inclusion in the current iteration (154). On the other hand, in response to determining that the gradient step is not greater than the threshold, CPU 6 may not select the particle for inclusion in the current iteration (156).

CPU 6 determines whether there are any additional particles to be processed (158). In response to determining that there are additional particles to be processed, CPU 6 proceeds to process block 148 to select the next particle for processing. Otherwise, in response to determining that all particles have been processed, CPU 6 ends the particle selection operation (160). CPU 6 may, in some examples, repeat the set of process blocks 148, 150, 152, 154 and 156 for each of the particles to be simulated in a frame.

As shown in FIG. 5, CPU 6 selectively includes particles in a current gradient descent or ascent iteration based on corresponding gradient steps from a previous iteration. Specifically, the technique in FIG. 5 excludes those particles for which the gradient step (i.e., the distance that the respective particle was moved as part of a previous gradient descent or ascent iteration) is relatively low. A relatively small gradient step for a particular particle often indicates that a particle is approaching its optimal position. In some cases, for relatively small gradient steps, the distance between the current particle position and the optimal particle position may be imperceptible to a viewer of the simulation, at least in terms of incompressibility. Therefore, by selectively excluding particles with relatively low gradient steps from subsequent gradient descent or ascent iterations, the overall computational complexity of the simulation may, in some examples, be reduced without resulting in a reduction in the perceived incompressibility of the simulated fluid. In this way, the computational and/or power requirements of simulating an incompressible fluid may be reduced.

To determine whether the gradient step is greater than the threshold (152), CPU 6 may, in some examples, use one of an L1 norm or an L2 norm. In some cases, using the L1 norm may further reduce the computational complexity of the particle selection process compared to the L2 norm. For example, CPU 6 may determine whether norm(delP)>delP_threshold, where delP is a vector, delP_threshold is a scalar, and norm( ) may be either an L1 norm or an L2 norm.

As discussed above, the technique shown in FIG. 5 may be used to select which particles to include in a gradient descent or ascent iteration, and thereby implement process block 132 of FIG. 4. For example, as shown in FIG. 5, CPU 6 may determine that all particles are included in a fixed number of initial iterations (numFixedIters). After the fixed number of initial iterations, if the gradient step (delP) in the previous iteration for a particular particle does not exceed a threshold (delP_threshold) in either the L1 or L2 norm, then that particle may be included in the current iteration. Once the CPU 6 determines which particles to include in a current iteration, CPU 6 may proceed to process block 134 of FIG. 4 to determine gradient steps for each of the particles.

FIG. 6 is a flow diagram illustrating an example technique for determining a gradient step according to this disclosure. In some examples, the technique illustrated in FIG. 6 may be used to implement process block 134 of FIG. 4. CPU 6 begins the gradient step determination process (162). CPU 6 selects a particle for processing (164).

CPU 6 determines the density for the selected particle (166). In some examples, CPU 6 may determine the density for the selected particle based on neighboring particles of the selected particle. The neighboring particles may be selected based on a radius (e.g., the h parameter). In other words, the neighboring particles for the selected particle may include all particles within a particular radius of the selected particle, and exclude all particles outside of a particular radius of the selected particle. The density for the selected particles may be calculated based at least in part on new particle positions as they become available (sequential mode), or after determining all the new particle positions (batch mode).

In some examples, the neighboring particles may be the same neighboring particles that were used to do velocity averaging (e.g., when velocity averaging is performed with the h radius). In further examples, the neighboring particles may be different than the neighboring particles that were used to do velocity averaging (e.g., when velocity averaging is performed with hv radius).

In some examples, CPU 6 may determine the density of the particle based on the following equation:

$${ρ}_{b} = {\sum }_{a} {m}_{a} W ( {r}_{a} - {r}_{b} , h ) \qquad ( 4 )$$

where ρ_{b} corresponds to the density of the selected particle, mₐ corresponds to a mass of an ath neighboring particle, rₐ corresponds to a position of the ath neighboring particle, r_{b} corresponds to a position of the bth particle, h corresponds to a radius used to identify neighboring particles, and W(rₐ−r_{b}, h) corresponds to an interpolation function of unit volume and radius h.

In some examples, to determine the distance between particles (e.g., rₐ−r_{b}), CPU 6 may, in some examples, use one of an L1 norm or an L2 norm. In some cases, using the L1 norm may further reduce the computational complexity of the particle selection process compared to the L2 norm.

CPU 6 determines the target density for the selected particle (168). In some examples, CPU 6 may determine the target density based on one or both of a mapping function and a history or recent density errors (or deviations) for the selected particle. In some examples, the mapping function may be a mapping function between the actual density for the selected particle (e.g., determined in process block 166) and the target density for the selected particle (e.g., targetRho). In other words, the mapping function may map an actual density for a selected particle to a target density for the selected particle. In further examples, the mapping function may be a non-linear mapping function.

In some cases, to determine a particle-specific target density based on a history of density errors, CPU 6 may determine whether the historical density for a particle are consistently higher or lower than the desired density for the particle. If the historical density for the particle is consistently higher than the desired density for the particle, then CPU 6 may lower the target density for the particle. On the other hand, if the historical density for the particle is consistently lower than the desired density for the particle, then CPU 6 may raise the target density for the particle.

In examples where a non-linear function is used to determine a particle-specific target density based on a history of density errors, if the historical density for the particle is higher than the desired density for a particle, then the non-linear function may cause CPU 6 to lower the target density for the particle. However, if the historical density for the particle is lower than the desired density for the particle, then the non-linear function may cause CPU 6 to maintain the target density for the particle. Using such a non-linear function may avoid raising the particle density in low-density areas of the fluid flow.

CPU 6 may accumulate historical density errors (error=actual density−desired density) and compare the accumulated historical density errors with zero to determine if the historical (actual) density is higher or lower than the desired density. Such a mapping that treats positive errors differently from negative errors may be an example of a nonlinear mapping discussed above. For example, CPU 6 may set target densities for particles with negative errors as equal to desired densities, rather than as higher than desired densities, in order to maintain low particle density in the areas where negative errors occurs.

As discussed above, CPU 6 may dynamically adjust the target density for each particle even in cases where the overall target density for the fluid remains constant. Dynamically adjusting particle-specific target densities may reduce the amount of computation that is needed to maintain incompressibility. For example, to more quickly compute desiredRho, CPU 6 may set a targetRho that is different from the desiredRho, such that CPU 6 may take larger gradient steps to get to desiredRho in fewer steps.

Once the target density is determined for the selected particle, CPU 6 determines the gradient step for the selected particle (170). In some examples, CPU 6 may determine the gradient step for the selected particle with respect to the following function (which may be referred to as an objective function):

$$C ( {r}_{1} , {r}_{2} , … , {r}_{N} ) = {\sum }_{b} {( {ρ}_{b} - {ρ}_{0} )}^{2} \qquad ( 5 )$$

where ρ₀ corresponds to a target density for the fluid flow, ρ_{b} corresponds to a density of the bth particle, and

$${ρ}_{b} = {\sum }_{a} {m}_{a} W ( {r}_{a} - {r}_{b} , h ) \qquad ( 6 )$$

where mₐ corresponds to a mass of an ath neighboring particle, rₐ corresponds to a position of the ath neighboring particle, r_{b} corresponds to a position of the bth particle, N corresponds to a total number of particles, h corresponds to a radius used to identify neighboring particles, and W(rₐ−r_{b}, h) corresponds to an interpolation function of unit volume and radius h. CPU 6 may determine the gradient step for the selected particle by taking the partial derivative of equation (5) with respect to the position of the selected particle (e.g., rₙ) and evaluating the partial derivative at that position.

In some examples, CPU 6 may determine the gradient step for the selected particle based on one or more tensile forces.

In further examples, CPU 6 may use fresh rhos for some neighbors and stale rhos for others (sequential mode). As CPU 6 iterate over particles, the rhos of some particles may get updated, and thereby may have fresh rhos, while the rhos of other particles are yet to be updated, and thereby may have old rhos. The position updates may occur after all the rho updates, such that the fresh and stale rhos are not produced by fresh and stale positions.

After determining the gradient step (delP), CPU 6 may cap each of the dimensions of the gradient step at a threshold value (172). In some examples, the threshold value used for capping the gradient step may correspond to the maxDelP parameter discussed above. Capping a dimension of a gradient step may refer to the process of setting the value for the dimension equal to the threshold value if the dimensional value is greater than the threshold value, and maintaining the dimensional value if the dimensional value is not greater than the threshold value.

CPU 6 determines whether there are any additional particles to be processed (174). In response to determining that there are additional particles to be processed, CPU 6 proceeds to process block 164 to select the next particle for processing. Otherwise, in response to determining that all particles have been processed, CPU 6 ends the gradient step determination process (176). CPU 6 may, in some examples, repeat process blocks 166, 168, 170, and 172 for each of the particles to be simulated in a frame. In some examples, CPU 6 may use symmetry to reduce the number of repeated computations.

FIG. 7 is a flow diagram illustrating an example technique for modifying a position based on a gradient step according to this disclosure. In some examples, the technique illustrated in FIG. 7 may be used to implement process block 136 of FIG. 4. CPU 6 begins the position update process (178). CPU 6 selects a particle for processing (180).

CPU 6 modifies the particle position of the selected particle based on the gradient step for the selected particle to generate a modified position for the particle (182). In some examples, CPU 6 may generate the modified particle position based on the following equation:

xp=xp+delP (7)

where the xp on the left-hand side of equation (7) corresponds to the modified particle position for the selected particle, the xp on the right-hand side of equation (7) corresponds to the provisional particle position for the selected particle, and delP corresponds to the gradient step for the selected particle.

CPU 6 resolves particle collisions (184). For example, CPU 6 may resolve particle collisions into walls or objects by reflecting, and may modify the particle positions based on the resolved collisions (if needed).

CPU 6 determines whether there are any additional particles to be processed (186). In response to determining that there are additional particles to be processed, CPU 6 proceeds to process block 180 to select the next particle for processing. Otherwise, in response to determining that all particles have been processed, CPU 6 ends the position update process (186). CPU 6 may, in some examples, repeat process blocks 182 and 184 for each of the particles included in a gradient ascent or descent iteration.

As discussed above, the technique illustrated in FIG. 7 may implement process block 136 of the technique illustrated in FIG. 4, which may further implement process block 106 of the technique illustrated in FIG. 2, which may generate modified particle positions based on one or more target densities. The modified particle positions generated by process blocks 182 and 184 may correspond to the modified particle positions generated by process block 106 in FIG. 2.

As shown in FIG. 2, CPU 6 may generate modified particle velocities based on the modified particle positions (108). In some examples, CPU 6 may generate the modified particle velocities based on the following equation:

vt=(xp−x)/dt (8)

where vt corresponds to a modified particle velocity, xp corresponds to a modified particle position, x corresponds to an initial particle position, and dt corresponds to a time step.

In some examples, after generating the modified particle velocity, CPU 6 may assign the modified particle position to the x variable. In other words, x=xp, where xp is the modified particle position generated by process block 106.

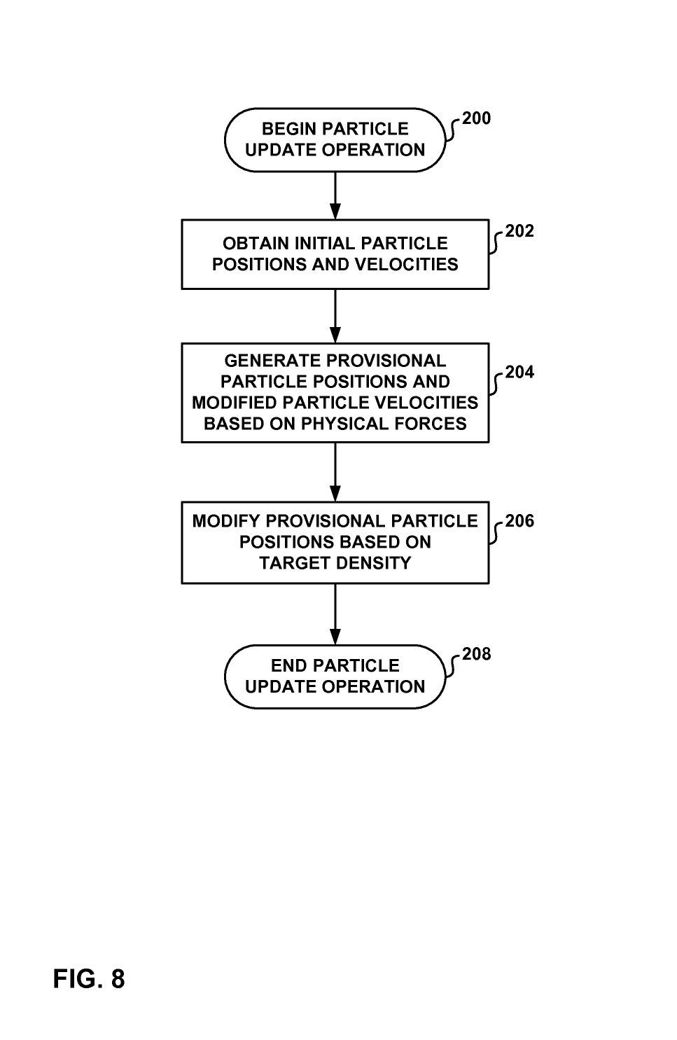

FIG. 8 is a flow diagram illustrating an example technique for simulating fluid flow according to this disclosure. CPU 6 begins the particle update operation (200). CPU 6 obtains initial particle positions for a plurality of particles and initial particle velocities for the plurality of particles (202). The particles may represent a fluid flow that is to be simulated. CPU 6 generates provisional particle positions and modified particle velocities for the particles based on the initial particle positions, the initial particle velocities, and a model that models one or more physical forces (204). In some examples, the one or more physical forces may include a gravitational force (i.e., gravity). CPU 6 modifies the provisional particle positions based on a target density for the particles to generate modified particle positions for the particles (206). CPU 6 ends the particle update operation (208).

In some examples, CPU 6 may perform the particle update operation once for each unit of time in which the particles are updated. For example, the unit of time may be a frame, and CPU 6 may perform the particle update operation once for each frame in which the particles are to be updated. In further examples, the initial particle positions and particle velocities may be final particle positions and particle velocities that were generated for a previous unit of time (e.g., a previous frame), and the modified particle positions and particle velocities may be particle positions and velocities that are generated for a current unit of time (e.g., a current frame). The current unit of time may occur after the previous unit of time.

In some examples, CPU 6 may modify the provisional particle positions based on a target density in order to maintain the incompressibility of a fluid flow that is being simulated over time. For example, CPU 6 may, in some examples, modify the provisional particle positions such that the density of the particles remains approximately the same over time (e.g., from a previous unit of time to a subsequent unit of time). In some examples, the target density for a current unit of time may be equal to a target density for a previous unit of time.

To modify the provisional particle positions, CPU 6 may, in some examples, approximate a solution to a quadratic minimization problem. The approximated solution to the quadratic minimization problem may define the modified particle positions that are used for the current unit of time. For example, the quadratic minimization problem may be defined to minimize a cost function that defines a total density error for the particles based on current particle positions for the particles and based on a target density for the fluid flow. By modifying the particle positions based on an approximate solution to a quadratic minimization problem that minimizes total density error, the incompressibility of the simulated fluid flow may be maintained.

In some examples, the quadratic minimization problem may be defined based on the following equations:

$$\begin{matrix}{min}_{{r}_{b}} {\sum }_{b} {( {ρ}_{b} - {ρ}_{0} )}^{2} & ( 9 ) \\ {ρ}_{b} = {\sum }_{a} {m}_{a} W ( {r}_{a} - {r}_{b} , h ) & ( 10 )\end{matrix}$$

where ρ₀ corresponds to a target density for the fluid flow, ρ_{b} corresponds to a density of the bth particle, r_{b} corresponds to a position of the bth particle, mₐ corresponds to a mass of the ath neighboring particle, rₐ corresponds to a position of the ath neighboring particle, h corresponds to a radius used to identify neighboring particles, and W(rₐ−r_{b}, h) corresponds to an interpolation function of unit volume and radius h.

In some examples, to approximate a solution to the quadratic minimization problem, CPU 6 may perform one or more gradient descent iterations with respect to equation (9). Each of the gradient descent iterations may produce modified particle positions. In some cases, the gradient descent iterations may cause the total density for the fluid to approach the target density for the fluid.

In further examples, to modify the provisional particle positions, CPU 6 may perform one or more gradient descent iterations with respect to a cost function. The cost function may define a total density error for the particles based on current particle positions for the particles and based on a target density. In such examples, the cost function may be defined as:

$${\sum }_{b} {( {ρ}_{b} - {ρ}_{0} )}^{2} \qquad ( 11 )$$

where ρ₀ corresponds to a target density for the fluid flow, ρ_{b} corresponds to a density of the bth particle, and

$${ρ}_{b} = {\sum }_{a} {m}_{a} W ( {r}_{a} - {r}_{b} , h ) \qquad ( 12 )$$

where mₐ corresponds to a mass of the ath neighboring particle, rₐ corresponds to a position of the ath neighboring particle, r_{b} corresponds to a position of the bth particle, h corresponds to a radius used to identify neighboring particles, and W(rₐ−r_{b}, h) corresponds to an interpolation function of unit volume and radius h.

In further examples, CPU 6 may dynamically adjust the number of gradient descent iterations that are performed for each fluid particle while solving for incompressibility. Dynamically adjusting the number of gradient descent iterations for each particle may reduce the amount of computation that is needed to maintain incompressibility.

For example, after a gradient descent iteration has been performed, for some or all of the particles, CPU 6 may determine a distance that the respective particle was moved as part of the gradient descent iteration, and selectively perform a subsequent gradient descent iteration for the respective particle based on the distance that the respective particle was moved as part of the gradient descent iteration. In some examples, to selectively performing the subsequent gradient descent iteration for the respective particle, CPU 6 may determine whether the distance that the respective particle was moved as part of the gradient descent iteration is greater than a threshold. In response to determining that the distance that the respective particle was moved as part of the gradient descent iteration is greater than the threshold, CPU 6 may perform the subsequent gradient descent iteration for the respective particle. In response to determining that the distance that the respective particle was moved as part of the gradient descent iteration is not greater than the threshold, CPU 6 may not perform the subsequent gradient descent iteration for the respective particle.

In general, relatively small amounts of particle movement that occur in response to a gradient descent iteration indicate that the particle is likely to be near the appropriate position for a particular target density, while relatively large amounts of particle movement indicate that the particle is not likely to be near the appropriate position for a particular target density. Selectively performing subsequent gradient descent iterations for specific particles in this manner may conserve computing resources for those particles that are relatively far from their appropriate positions for a particular target density, while avoiding wasting computing power for particles that are relatively near their appropriate positions for a particular target density.

In additional examples, CPU 6 may dynamically adjust the target density for each particle even in cases where the overall target density for the fluid remains constant. Dynamically adjusting particle-specific target densities may reduce the amount of computation that is needed to maintain incompressibility.

For example, a cost function may define the total density error for the particles based on the current particle positions for the particles and based on a plurality of particle-specific target densities. In such an example, CPU 6 may determine the plurality of particle-specific target densities, and perform the one or more gradient descent iterations with respect to the cost function based on the particle-specific target densities.

In some examples, to determine the particle-specific densities, CPU 6 may, for each of the particles, determine a particle-specific target density for the respective particle based on a history of one or more density errors for the respective particle. The history of density errors for a particle may correspond to density errors that are associated with one or more previous iterations of the gradient descent algorithm and/or associated with the provisional particle positions.

In some cases, to determine a particle-specific target density based on a history of density errors, CPU 6 may determine whether the historical density errors for a particle are consistently higher or lower than the target density for the particle. If the historical density errors for the particle are consistently higher than the target density for the particle, then CPU 6 may lower the target density for the particle. On the other hand, if the historical density errors for the particle are consistently lower than the target density for the particle, then CPU 6 may raise the target density for the particle.

In further cases, CPU 6 may use a non-linear function to determine a particle-specific target density based on a history of density errors. For example, if the historical density errors for the particle are higher than the target density for a particle, then the non-linear function may cause CPU 6 to lower the target density for the particle. However, if the historical density errors for the particle are lower than the target density for the particle, then the non-linear function may cause CPU 6 to maintain the target density for the particle. Using such a non-linear function may avoid raising the target particle density in low-density areas of the fluid flow.

In some examples, to generate the provisional positions and modified velocities, CPU 6 may perform particle velocity averaging. Performing particle velocity averaging may improve stability and/or provide viscosity control.

For example, CPU 6 may average initial particle velocities for neighboring particles to generate average particle velocities for each of the particles, and generate the provisional particle positions and the modified particle velocities for the particles based on the initial particle positions, the average particle velocities, and the model that models the one or more physical forces. In some examples, to average the initial particle velocities for the neighboring particles, CPU 6 may, for each of the particles, average an initial particle velocity for the respective particle and initial particle velocities for neighboring particles that neighbor the respective particle based on a smoothing function to generate an average particle velocity for the respective particle.

In further examples, CPU 6 may select a radius for determining which particles qualify as neighboring particles for velocity averaging based on a target viscosity of a fluid to be simulated by the particles. In such examples, CPU 6 may determine which particles qualify as neighboring particles for velocity averaging based on the selected radius. In such examples, to increase the viscosity of the liquid being simulated, CPU 6 may, in some examples, increase the radius used for determining neighboring particles. Similarly, in such examples, to decrease the viscosity of the liquid being simulated, CPU 6 may, in some examples, decrease the radius used for determining neighboring particles

In some examples, CPU 6 may detect and limit particle dynamics that occur for a given gradient descent. Limiting the particle dynamics that occur for a given gradient descent may be used to maintain stability.

For example, after a gradient descent iteration has been performed, for some or all of the particles, CPU 6 may determine a distance that the respective particle was moved as part of a gradient descent iteration, and selectively modify a position of the respective particle based on the distance that the respective particle was moved as part of the gradient descent iteration. In some examples, to selectively modify the position of the respective particle based on the distance, CPU 6 may determine whether the distance that the respective particle was moved as part of the gradient descent iteration is greater than a threshold. In response to determining that the distance that the respective particle was moved as part of the gradient descent iteration is greater than the threshold, CPU 6 may modify a position of the respective particle such that the distance between the modified position for the respective particle and a position of the respective particle prior to performing the gradient descent iteration is less than or equal to the threshold. In response to determining that the distance that the respective particle was moved as part of the gradient descent iteration is not greater than the threshold, CPU 6 may not modify the position of the respective particle.

In general, relatively large amounts of particle movement that result from a single gradient descent iteration may cause the resulting fluid flow to appear unstable. Placing an upper limit on the movement that occurs during a single gradient descent iteration may prevent unstable fluid flow effects from occurring.

In some examples, CPU 6 may be configurable to update particle data in a batch mode and/or in a sequential mode when performing a gradient descent iteration. In general, performing a gradient descent iteration may involve generating updated particle positions for the particles based on previous particle positions for the particles. When using the batch mode to update particle positions, CPU 6 may, for each the particles, generate an updated position for the respective particle based on the previous positions for the particles. When using the sequential mode to update the particle positions, CPU 6 may, for each the particles, generate an updated position for the respective particle based on previous positions for particles that have not yet been updated by the gradient descent iteration and based on updated particle positions for particles that have already been updated by the gradient descent iteration. Using the sequential mode may allow symmetry to be exploited, thereby reducing the amount of computation needed to update particle positions.

In some examples, CPU 6 may scale the number of particles to match viscosity requirements. Scaling the number of particles in this manner may avoid oversampling, thereby reducing computation requirements. In some examples, CPU 6 may select one or more of a number of particles to use for simulating a fluid, a radius for calculating particle densities, a radius for averaging volumes, a target density and a minimum target viscosity.

In further examples, CPU 6 may use L1 norms to determine distances between particles. For example, CPU 6 may use an L1 norm to determine distances between particles, and determine which particles qualify as neighboring particles for velocity averaging and/or density calculation based on the selected radius and the determined distances between the particles.

In some examples, the techniques of this disclosure may provide liquid flow models for mobile gaming. Games are becoming increasingly popular applications on mobile devices. Games may use realistic, real-time simulations of the physical world to tap directly into user intuition for dynamics, and to create open-ended gameplay rather than scripted video.

Physics engines may be used to perform the underlying calculations for the simulations of the physical world. For example, physics engines may simulate rigid body dynamics, soft/deformable bodies, cloth, etc. Due to computational and data path limitations, realistic, real-time fluid simulations are difficult to implement on mobile platforms.

Some types of fluid simulations may be based on the Navier-Stokes equations for fluids. The Navier-Stokes equations are based on Newton's Second Law, and may take the form of second-order partial differential equations (PDEs). The PDEs may include a momentum equation and a mass continuity equation. The Navier-Stokes equations may involve density, velocity, pressure, external forces. In some examples, the Navier-Stokes equations may take the following form:

$$\begin{matrix}ρ ( \frac{\partial v}{\partial t} + v \cdot ∇ v ) = - ∇ p + μ {∇}^{2} v + f & ( 13 ) \\ ∇ \cdot v = 0 & ( 14 )\end{matrix}$$

where ρ corresponds to the density of the fluid, v corresponds to the flow velocity, p corresponds to the pressure, μ corresponds to the dynamic viscosity, f corresponds to body forces acting on the fluid, and ∇ corresponds to the del operator. An additional property for liquids may include incompressibility, which may be a significant property for visual realism.

Techniques for solving Navier-Stokes equations include Eulerian techniques and Lagrangian techniques. Eulerian techniques may be grid-based or mesh-based methods (e.g. Finite Element/Volume Methods), and may track the movement of fluid through specific fixed locations. Lagrangian techniques may be particle based (e.g. Smoothed Particle Hydrodynamics (SPH)), and may track individual fluid particles.

Techniques for handling dynamics include impulse-based techniques and position-based techniques. Impulse-based techniques may work with forces to manipulate positions. Position-based techniques may directly manipulate positions.

In some examples, the techniques of this disclosure may use SPH in a position-based framework. Field functions may be computed using neighbors within a certain radius and by using an interpolation function. For example, the field functions may be computed as follows:

$$\begin{matrix}A ( r ) = {\sum }_{b} {m}_{b} \frac{{A}_{b}}{{ρ}_{b}} W ( r - {r}_{b} , h ) & ( 15 ) \\ ∇ A ( r ) = {\sum }_{b} {m}_{b} \frac{{A}_{b}}{{ρ}_{b}} ∇ W ( r - {r}_{b} , h ) & ( 16 )\end{matrix}$$

where W(r, h) represents an interpolation function (or kernel) of unit volume and radius h, ρ_{b} represents the mass density, m_{b} represents the mass, and A_{b} represents the function value at particle b. SPH can be viewed as function (r) estimation from finite set of points r_{b}. Equation (16) may correspond to the spatial derivative of equation (15). Dynamics (e.g., from Navier-Stokes equations) may be computed for particles.

SPH may provide one or more of the following advantages. For example, in SPH, the particles may define the location where the liquid actually is, and a simulator may not need to use a grid. In SPH, the particles may interact cleanly with other game elements like rigid and soft bodies. In addition, SPH updates may be able to be efficiently implemented.

Still, solving true Navier-Stokes equations for SPH may be very computationally complex, and in some cases, may be too computationally complex for real-time mobile gaming. In some examples, the techniques of this disclosure may maintain the realistic appearance of a liquid by maintaining both fluidity and incompressibility.

In some examples, the techniques of this disclosure may be able to be implemented on a mobile architecture. For example, the techniques of this disclosure may be able to be implemented on architectures where the CPU processing (e.g. 4 or 8 cores) is shared by other aspects of a game/simulation, where power consumption and thermals may need to be controlled and limited, and/or where memory bandwidth and cache sizes are more constraining than other non-mobile platforms.

In some examples, it may be visually sufficient to maintain incompressibility by finding a “close-by” solution. For example, the techniques of this disclosure may, in some examples, update particles locations with physics (e.g. gravity and particle velocity), and then enforce uniform density as error minimization. In such examples, the techniques of this disclosure may pose incompressibility as a quadratic minimization problem that corresponds to equations (9) and (10). In equation (10), densities are computed using neighbor locations. In some examples, the techniques of this disclosure may solve for a set of particle positions that minimizes equation (9) using gradient descent iterations. In some examples, the computations may involve information about neighbors within a certain radius.

In some examples, the technique of this disclosure may perform velocity averaging for viscosity control. For example, after solving for uniform density (ρ_{b}), the techniques of this disclosure may, in some examples, update each particle velocity based on the new position. However, to simulate liquid viscosity, nearby particles may need to affect each other's movement. In some examples, the techniques of this disclosure may capture this effect by using a kernel for velocity averaging. The range of the kernel may determine the viscosity of the liquid.

In some examples, spatial velocity averaging may determine the granularity needed for sampling (e.g., the particle spatial sample rate). For example, if a relatively high viscosity is desired, the physical simulator may use a lower particle density. A lower particle density may result in less computation for the same volume. The techniques of this disclosure may allow a designer to determine the appropriate particle density for a given design goal.

In some examples, the techniques of this disclosure may dynamically adjust the number of gradient descent iterations that are performed. If a particle is moved by a relatively small amount in a current iteration, then the simulator may skip the remaining iterations for that particle. In this way, the amount of computations needed to simulate a fluid may be reduced.

In further examples, the techniques of this disclosure may target a different density from desired density to get to desired density faster. In some cases, the simulator may use an adaptive step size for gradient descent. In additional cases, the simulator may adjust the gradient descent based on a recent history of errors. In further cases, the simulator may use integral control to adjust the gradient descent.

In additional examples, the techniques of this disclosure may make use of pairwise computations. For examples, a simulator may determine neighbors that have a reciprocal relation, and design data structures accordingly.

In further examples, a simulator may compute gradient steps in a sequential mode or a batch mode. In some examples, the particle ordering of the sequential mode may improve memory access efficiency.

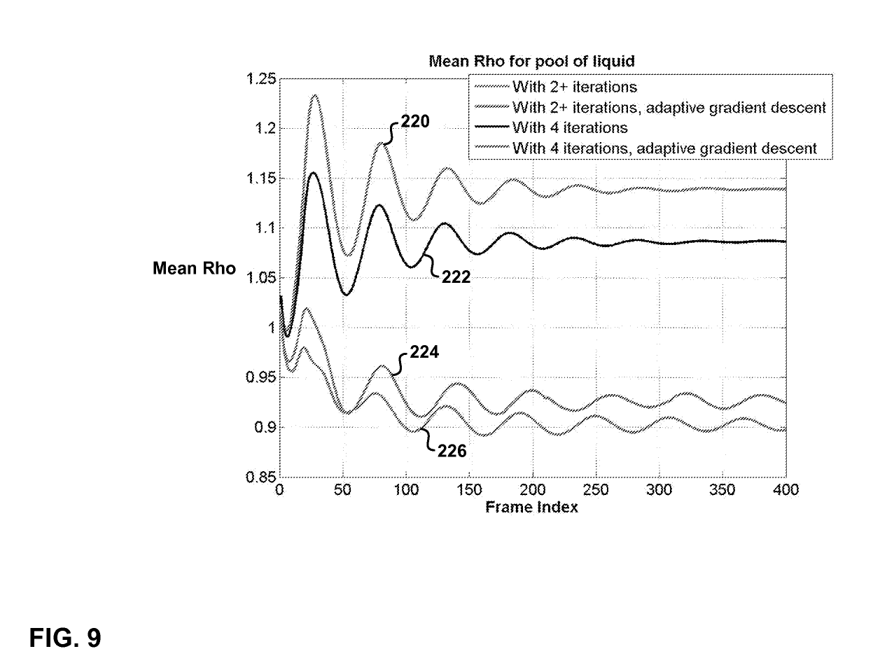

FIG. 9 is a diagram illustrating example mean densities that may result when simulating an example pool of liquid using one or more of the techniques of this disclosure. In the example simulation of FIG. 9, the desired density may be 0.9. FIG. 9 includes four lines 220, 222, 224, 228 indicative of mean densities (rhos) associated with different simulation parameters. Line 220 is indicative of a mean density associated with 2+ iterations without an adaptive gradient descent. Line 222 is indicative of a mean density associated with 4 iterations without an adaptive gradient descent. Line 224 is indicative of a mean density associated with 2+ iterations with an adaptive gradient descent. Line 226 is indicative of a mean density associated with 4 iterations with an adaptive gradient descent.

Physics engines may be used in gaming applications to simulate realistic interactions involving rigid bodies, soft bodies, fluids etc. Due to computational and data path limitations presented by mobile device architectures, realistic, real-time interactions involving fluids are believed by some to be beyond the capability of mobile devices.

In some examples, the techniques of this disclosure may provide visually-realistic, real-time fluid simulation that may be executed on a mobile platform. The techniques of this disclosure may include, in some examples, a fluid simulation algorithm and optimizations that enable the fluid simulation algorithm to run efficiently on a mobile device.

The techniques for simulating fluid flow may, in some examples, be based on Smoothed Particle Hydrodynamics (SPH) techniques, in which the fluid may be modeled as a set of particles that follow certain laws. In some cases, instead of basing the laws directly on the Navier-Stokes equation, the techniques of this disclosure may, in some examples, focus primarily and directly on maintaining incompressibility and viscosity, which may significantly reduce computational requirements.

In some examples, the techniques for simulating fluid flow described in this disclosure may involve one or more of the following: (1) solving for incompressibility by posing a quadratic minimization problem and using gradient descent iterations; (2) dynamically adjusting the number of iterations each fluid particle undergoes while solving for incompressibility so that computation is reduced; (3) dynamically adjusting the target density for each particle even though the desired density is constant, to reduce computation and still maintain incompressibility; (4) performing particle velocity averaging for stability and viscosity control; (5) detecting and limiting particle dynamics to maintain stability; (6) running in both batch and sequential particle update modes for implementation flexibility; (7) scaling the number of particles to match viscosity requirements to avoid oversampling and hence reduce computation; and (8) effectively using of L1 norm instead of L2 norm for reduced computation.

This disclosure describes techniques for simulating liquid flow. The techniques for simulating liquid flow may, in some examples, provide visually-realistic, real-time fluid simulation that can be implemented on devices that may have relatively limited computational resources, computational speed and/or power, such as, e.g., a mobile device and/or a mobile phone.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry such as discrete hardware that performs processing.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be stored, embodied or encoded in a computer-readable medium, such as a computer-readable storage medium that stores instructions. Instructions embedded or encoded in a computer-readable medium may cause one or more processors to perform the techniques described herein, e.g., when the instructions are executed by the one or more processors. In some examples, the computer-readable medium may be a non-transitory computer-readable storage medium. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable storage media that is tangible.

Computer-readable media may include computer-readable storage media, which corresponds to a tangible storage medium, such as those listed above. Computer-readable media may also comprise communication media including any medium that facilitates transfer of a computer program from one place to another, e.g., according to a communication protocol. In this manner, the phrase “computer-readable media” generally may correspond to (1) tangible computer-readable storage media which is non-transitory, and (2) a non-tangible computer-readable communication medium such as a transitory signal or carrier wave.

Various aspects and examples have been described. However, modifications can be made to the structure or techniques of this disclosure without departing from the scope of the following claims.

What is claimed is:

1. A method comprising:
obtaining initial particle positions for a plurality of particles that model a fluid and initial particle velocities for the plurality of particles;
generating provisional particle positions for the plurality of particles based on the initial particle positions, the initial particle velocities, and a model that models one or more physical forces to be applied to the fluid; and
generating modified particle positions for the plurality of particles based on the provisional particle positions, one or more target densities for the plurality of particles, and a function that defines an aggregate density deviation for the plurality of particles as a function of particle-specific density deviations, each of the particle-specific density deviations being a function of an amount by which a density for a respective one of the plurality of particles differs from one of the one or more target densities, the density for the respective one of the plurality of particles being a function of current particle positions.

2. The method of claim 1, wherein generating the modified particle positions comprises:
approximating a solution to a problem that determines a set of particle positions which minimizes the aggregate density deviation for the plurality of particles, the approximated solution to the problem comprising the modified particle positions.

3. The method of claim 1, wherein generating the modified particle positions comprises:
performing one or more gradient descent iterations or one or more gradient ascent iterations with respect to the function that defines the aggregate density deviation for the plurality of particles as the function of the particle-specific density deviations to determine the modified particle positions.

4. The method of claim 1, wherein the one or more target densities comprise a plurality of particle-specific target densities, each of the particle-specific target densities corresponding to a target density for a respective one of the plurality of particles.

5. The method of claim 4, further comprising:
for each of the plurality of particles, determining a particle-specific target density for the respective particle based on a history of one or more density errors for the respective particle.

6. The method of claim 1, further comprising:
for each of the plurality of particles, performing a gradient descent or ascent iteration to determine a gradient step for the respective particle, the gradient step corresponding to a distance that the respective particle is to be moved as part of the gradient descent or ascent iteration; and
capping each of one or more dimensional values of the gradient step at a respective maximum value to generate a capped gradient step that includes the capped dimensional values; and
generating the modified positions for the plurality of particles based on the capped gradient step.

7. The method of claim 6, wherein capping each of the one or more dimensional values comprises, for each of the one or more dimensional values:
determining whether the respective dimensional value is greater than a maximum value that corresponds to the respective dimensional value;
setting a capped dimensional value that corresponds to the respective dimensional value equal to the maximum value in response to determining that the respective dimensional value is greater than the maximum value; and
setting the capped dimensional value that corresponds to the respective dimensional value equal to the respective dimensional value in response to determining that the respective dimensional value is not greater than the maximum value.

8. The method of claim 1, further comprising:
for each of the plurality of particles, determining a distance that the respective particle was moved as part of a gradient descent or ascent iteration;
for each of the plurality of particles, selectively performing a subsequent gradient descent or ascent iteration for the respective particle based on whether the distance that the respective particle was moved as part of the gradient descent or ascent iteration is greater than a threshold.

9. The method of claim 8, wherein selectively performing the subsequent gradient descent or ascent iteration for the respective particle comprises:
determining whether the distance that the respective particle was moved as part of the gradient descent or ascent iteration is greater than the threshold;
in response to determining that the distance that the respective particle was moved as part of the gradient descent or ascent iteration is greater than the threshold, performing the subsequent gradient descent or ascent iteration for the respective particle; and
in response to determining that the distance that the respective particle was moved as part of the gradient descent or ascent iteration is not greater than the threshold, not performing the subsequent gradient descent or ascent iteration for the respective particle.

10. The method of claim 1, wherein the function that defines the aggregate density deviation for the plurality of particles as the function of particle-specific density deviations further defines the aggregate density deviation as a sum of squared particle-specific density deviations, wherein each of the squared particle-specific density deviations corresponds to a square of a difference between a target density for the respective one of the plurality of particles and a density for the respective one of the plurality of particles, and wherein the density for the respective one of the plurality of particles is determined based on distances between the respective one of the plurality of particles and a plurality of neighboring particles.

11. The method of claim 1, wherein the function that defines the aggregate density deviation for the particles as the function of the particle-specific density deviations is defined as:
$$C ( {r}_{1} , {r}_{2} , … , {r}_{N} ) = {\sum }_{b} {( {ρ}_{b} - {ρ}_{0} )}^{2}$$
where ρ₀ corresponds to a target density for the fluid flow, ρ_{b} corresponds to a density of the bth particle, and
$${ρ}_{b} = {\sum }_{a} {m}_{a} W ( {r}_{a} - {r}_{b} , h )$$
where mₐ corresponds to a mass of an ath neighboring particle, rₐ corresponds to a position of the ath neighboring particle, r_{b} corresponds to a position of the bth particle, N corresponds to a total number of particles, h corresponds to a radius used to identify neighboring particles, and W(rₐ−r_{b}, h) corresponds to an interpolation function of unit volume and radius h.

12. The method of claim 1, wherein generating the provisional particle positions comprises, for each of the plurality of particles:
averaging initial particle velocities for neighboring particles of the respective particle to generate an average particle velocity for the respective particle; and
generating a provisional particle position for the respective particle based on an initial particle position for the respective particle, the average particle velocity for the respective particle, and the model that models the one or more physical forces.

13. The method of claim 12, further comprising:
selecting a radius for determining which of the plurality of particles qualify as the neighboring particles for the respective particle based on a target viscosity of the fluid; and
determining the neighboring particles to be used for generating the average velocity based on the selected radius.

14. The method of claim 1, wherein the initial particle positions correspond to particle positions for a previous frame, the initial particle velocities correspond to particle velocities for the previous frame, the modified particle positions correspond to particle positions for a current frame, and the current frame is subsequent to the previous frame.

15. A device comprising one or more processors configured to:
obtain initial particle positions for a plurality of particles that model a fluid and initial particle velocities for the plurality of particles;
generate provisional particle positions for the plurality of particles based on the initial particle positions, the initial particle velocities, and a model that models one or more physical forces to be applied to the fluid; and
generate modified particle positions for the plurality of particles based on the provisional particle positions, one or more target densities for the plurality of particles, and a function that defines an aggregate density deviation for the plurality of particles as a function of particle-specific density deviations, each of the particle-specific density deviations being a function of an amount by which a density for a respective one of the plurality of particles differs from one of the target densities, the density for the respective one of the plurality of particles being a function of current particle positions.

16. The device of claim 15, wherein the one or more processors are further configured to:
approximate a solution to a problem that determines a set of particle positions which minimizes the aggregate density deviation for the plurality of particles, the approximated solution to the problem comprising the modified particle positions.

17. The device of claim 15, wherein the one or more processors are further configured to:
perform one or more gradient descent iterations or one or more gradient ascent iterations with respect to the function that defines the aggregate density deviation for the plurality of particles as the function of particle-specific density deviations to determine the modified particle positions.

18. The device of claim 15, wherein the one or more target densities comprise a plurality of particle-specific target densities, each of the plurality of particle-specific target densities corresponding to a target density for a respective one of the plurality of particles.

19. The device of claim 18, wherein the one or more processors are further configured to, for each of the plurality of particles, determine a particle-specific target density for the respective particle based on a history of one or more density errors for the respective particle.

20. The device of claim 15, wherein the one or more processors are further configured to:
for each of the plurality of particles, perform a gradient descent or ascent iteration to determine a gradient step for the respective particle, the gradient step corresponding to a distance that the respective particle is to be moved as part of the gradient descent or ascent iteration; and
cap each of one or more dimensional values of the gradient step at a respective maximum value to generate a capped gradient step that includes the capped dimensional values; and
generate the modified positions for the plurality of particles based on the capped gradient step.

21. The device of claim 20, wherein the one or more processors are further configured to:
determine whether the respective dimensional value is greater than a maximum value that corresponds to the respective dimensional value;
set a capped dimensional value that corresponds to the respective dimensional value equal to the maximum value in response to determining that the respective dimensional value is greater than the maximum value; and
set the capped dimensional value that corresponds to the respective dimensional value equal to the respective dimensional value in response to determining that the respective dimensional value is not greater than the maximum value.

22. The device of claim 15, wherein the one or more processors are further configured to:
for each of the plurality of particles, determine a distance that the respective particle was moved as part of a gradient descent or ascent iteration;
for each of the plurality of particles, selectively perform a subsequent gradient descent or ascent iteration for the respective particle based on whether the distance that the respective particle was moved as part of the gradient descent or ascent iteration is greater than a threshold.

23. The device of claim 22, wherein the one or more processors are further configured to:
determine whether the distance that the respective particle was moved as part of the gradient descent or ascent iteration is greater than the threshold;
in response to determining that the distance that the respective particle was moved as part of the gradient descent or ascent iteration is greater than the threshold, perform the subsequent gradient descent or ascent iteration for the respective particle; and
in response to determining that the distance that the respective particle was moved as part of the gradient descent or ascent iteration is not greater than the threshold, not perform the subsequent gradient descent or ascent iteration for the respective particle.

24. The device of claim 15, wherein the function that defines the aggregate density deviation for the plurality of particles as the function of particle-specific density deviations further defines the aggregate density deviation as a sum of squared particle-specific density deviations, wherein each of the squared particle-specific density deviations corresponds to a square of a difference between a target density for the respective one of the plurality of particles and a density for the respective one of the plurality of particles, and wherein the density for the respective one of the plurality of particles is determined based on distances between the respective one of the plurality of particles and a plurality of neighboring particles.

25. The device of claim 15, wherein the function that defines the aggregate density deviation for the plurality of particles as the function of particle-specific density deviations is defined as:
$$C ( {r}_{1} , {r}_{2} , … , {r}_{N} ) = {\sum }_{b} {( {ρ}_{b} - {ρ}_{0} )}^{2}$$
where ρ₀ corresponds to a target density for the fluid flow, ρ_{b} corresponds to a density of the bth particle, and
$${ρ}_{b} = {\sum }_{a} {m}_{a} W ( {r}_{a} - {r}_{b} , h )$$
where mₐ corresponds to a mass of an ath neighboring particle, rₐ corresponds to a position of the ath neighboring particle, r_{b} corresponds to a position of the bth particle, N corresponds to a total number of particles, h corresponds to a radius used to identify neighboring particles, and W(rₐ−r_{b}, h) corresponds to an interpolation function of unit volume and radius h.

26. The device of claim 15, wherein the one or more processors are further configured to, for each of the plurality of particles:
average initial particle velocities for neighboring particles of the respective particle to generate an average particle velocity for the respective particle; and
generate a provisional particle position for the respective particle based on an initial particle position for the respective particle, the average particle velocity for the respective particle, and the model that models the one or more physical forces.

27. The device of claim 26, wherein the one or more processors are further configured to:
select a radius for determining which of the plurality of particles qualify as the neighboring particles for the respective particle based on a target viscosity of the fluid; and
determine the neighboring particles to be used for generating the average velocity based on the selected radius.

28. The device of claim 15, wherein the device comprises at least one of a wireless communication device and a mobile phone handset.

29. An apparatus comprising:
means for obtaining initial particle positions for a plurality of particles that model a fluid and initial particle velocities for the plurality of particles;
means for generating provisional particle positions for the plurality of particles based on the initial particle positions, the initial particle velocities, and a model that models one or more physical forces to be applied to the fluid; and
means for generating modified particle positions for the plurality of particles based on the provisional particle positions, one or more target densities for the plurality of particles, and a function that defines an aggregate density deviation for the plurality of particles as a function of particle-specific density deviations, each of the particle-specific density deviations being a function of an amount by which a density for a respective one of the plurality of particles differs from one of the target densities, the density for the respective one of the plurality of particles being a function of current particle positions.

30. A non-transitory computer readable storage medium comprising instructions that upon execution by one or more processors cause the one or more processors to:
obtain initial particle positions for a plurality of particles that model a fluid and initial particle velocities for the plurality of particles;
generate provisional particle positions for the plurality of particles based on the initial particle positions, the initial particle velocities, and a model that models one or more physical forces to be applied to the fluid; and
generate modified particle positions for the plurality of particles based on the provisional particle positions, one or more target densities for the plurality of particles, and a function that defines an aggregate density deviation for the plurality of particles as a function of particle-specific density deviations, each of the particle-specific density deviations being a function of an amount by which a density for a respective one of the plurality of particles differs from one of the target densities, the density for the respective one of the plurality of particles being a function of current particle positions.
